(19) United States
(12) Patent Application Publication
(10) Pub. No.: US 2003/0151157 A1
(43) Pub. Date: Aug. 14, 2003

(54) Method for reducing formaldehyde content and formaldehyde emission from particle board

(76) Inventor: Iwona Frackowiak, Poznen (PL)

Correspondence Address: NIXON & VANDERHYE, PC, 1100 N GLEBE ROAD, 8TH FLOOR, ARLINGTON, VA, 22201-4714, US

(21) Appl. No.: 10/311,594

(22) PCT Filed: May 3, 2001
(86) PCT No.: PCT/EP01/04959

(51) Int. Cl. B27N 3/00

(52) U.S. Cl. 264/109

(57) ABSTRACT

The method for reducing formaldehyde content and emission from particleboard according to the invention, where in particleboard manufacturing process carried out in a known standard way, with known run; with the application of known amino adhesive resins; with the addition of known hardening agents and/or possible addition of formaldehyde-bonding substances; pressing in stroke or continuous-run presses and cooling, characteristic in that particleboard after pressing, prior to cooling, is subjected to brief seasoning in 70-110° C. for several up to a few dozen hours, preferably from 8-16 hours, depending on the expected reduction rate of formaldehyde content and emission and applied manufacturing process parameters.

The subject-matter of the invention is a method for producing a board and especially a method for reducing the formaldehyde content and formaldehyde emission from particleboard, to be used in the manufacturing process of particleboards, pressed in stroke and continuous-run presses, with the application of amino adhesive resins.

A method for producing a panel in accordance with the invention is known from GB 2 354 482. This document is incorporated by reference herewith.

Nowadays, we know of many methods for reducing the formaldehyde content and formaldehyde emission from particleboard. The major ones are:

modification of adhesive resins, usually by the reduction of formaldehyde molar rate to urea, which most frequently leads to lessening of resin reactivity, but many times also to weaker strength of adhesive-bonded joints and their resistance to water;

addition of formaldehyde-bonding substances. Such substances, however, may often exert negative impact on physical and mechanical properties of particleboard;

mixing of urea-formaldehyde resins with other resins, e. g. resorcinol or phenolic ones. This in turn, is followed by substantial production cost increase;

extension of particleboard pressing time. Followed by decrease in production capacity;

drying of particles down to extremely low moisture content. Application is restricted by technical conditions and safety precautions due to possible ignition in drier;

processing of particleboard with gaseous ammonia. This method requires special hermetic chambers for safety reasons;

processing of finished particleboard with hot air in special chambers with forced intensive air exchange. This method, taking into account the actual production line capacity, would require additional special production facility in order to maintain smooth production flow;

surface processing of finished particleboard by means of solutions of substances that come into reaction with formaldehyde. This necessitates special installation, and on the other hand there is a risk the surface quality in such particleboard would deteriorate.

As pointed out above, the presented, popular methods for reducing the formaldehyde content and formaldehyde emission from particleboard either necessitate substantial financial expenditures and operation of additional devices and installations, or some of them can also exert negative impact on production efficiency by decreasing process capacity and/or deteriorating the quality of particleboard manufactured according to such methods.

The essence of the invention for reducing the formaldehyde content and formaldehyde emission from particleboard manufactured based on the standard method providing for a known run with the use of known amino adhesive resins with the addition of known hardening agents and/or possible addition of formaldehyde-bonding substances, where pressing takes place in stroke or continuous-run presses, consists in that the particleboard after pressing, prior to cooling, is subjected to short-time seasoning in 70-110° C. through several minutes up to a few dozen hours, preferably from 8 to 16 hours depending on the expected reduction of formaldehyde content and formaldehyde emission and applied production process parameters.

To date, the popular particleboard manufacturing methods with the application of amino resins, necessitate the particleboard cooling immediately after pressing and prior to seasoning. The cooling process takes place on rotary coolers where particleboard stays from several to a few dozen minutes, most often for the time required to decrease the particleboard internal layer temperature down to 45-60° C.

Unexpectedly, it appeared that the heat cumulated in the board or a particleboard while it is pressed, can be utilised to deepen the adhesive resin polycondensation process, which, as it should be judged, cannot be fully completed in the press due to very short board pressing cycles. The incomplete adhesive hardening can be a cause for formaldehyde splitting, consequently a rise of its content and its emission from particleboard; the emission can be long-lasting, especially in storage conditions and during implementation, which leads to considerable increase of particleboard moisture content. Short seasoning of particleboard after pressing, consistent with the invention essence, replaces to some extent the extension of particleboard pressing time. Whereas the positive influence of pressing time extension on the board's hygienic properties is already a canon in particleboard manufacturing technology. It is also known, however, that its practical application is limited due to economic aspects. On the other hand, increasing the reactivity of resins in one of the conditions for the application of technical opportunities offered by the continuous particleboard pressing system that has been introduced over the last couple of years; this additionally confirms the importance of hardening.

The to-date particleboard cooling and seasoning processes provided for test of temperature to be attained prior to seasoning, to avoid hydrolysis of adhesive-bonded joints, consequently to avoid particleboard strength diminishing. The temperature actually attained in cooling has not been controlled. For it was assumed that the lowest possible temperature was most wanted. For this reason, in modem facilities we have systems of rotary coolers instead of single devices, e.g. three rotary coolers where particleboards are successively delivered to.

The invention allows for drastic reduction of formaldehyde content and its emission from particleboard, without the need for significant changes in the actual technical and technological conditions prevailing in particleboard factories, regardless of the production line equipment, pressing process parameters, timber, and chemicals. The described above solution permits to stabilise the particleboard hygienic quality. It provides for the production of particleboard characterised by special hygienic quality, and also for higher particleboard production efficiency due to possible application of resins features with increased molar formaldehyde to urea ratio. For tests and industrial trial technical applications of this invention revealed reduction of formaldehyde content and emission even by 70% as compared with particleboard manufactured in conventional way, i. e. cooled after pressing. The parameters of short-time seasoning prior to cooling, i. e. temperature and time, are set depending on the expected reduction rate of formaldehyde content and emission, with due regard to characteristics of adhesive resin and application directions.

The invention subject-matter is presented below in a few practical examples illustrated with drawings. FIGS. 1-3 show comparative diagrams of particleboard hygienic properties, manufactured in conventional and invention method.

### EXAMPLE I

To manufacture particleboard, urea-formaldehyde adhesive resin was used; urea for formaldehyde molar rate 1.0:1.5. Ammonium nitrate was the hardening agent. Particleboard pressing temperature: 205° C.; at 6 s/1 mm particleboard thickness pressing time rate.

The formaldehyde content in particleboard cooled conventionally after pressing was 10.3 mg/100 mg totally dry board, whereas formaldehyde emission—some 14.9 mg/1 kg totally dry board (t.d.b.). In the invention method the addition of the hardening agent to the adhesive on surface layers was reduced by 50%.

Pursuant to the invention, the board was seasoned prior to cooling for 16 hours; whereas the temperature in the internal particleboard layer during stock-piling for brief seasoning, was 95-100° C. The formaldehyde content and emission were reduced down to 4.1 mg/100 mg totally dry board and 8.1 mg/1 kg totally dry board, respectively. Thereby the formaldehyde content and emission changed positively after seasoning; whereas other particleboard properties were at the same level as in conventional production. The example is illustrated in FIG. 1:

1: values for board seasoned prior to cooling;

2: values for board manufactured in conventional way (cooled after pressing).

### EXAMPLE II

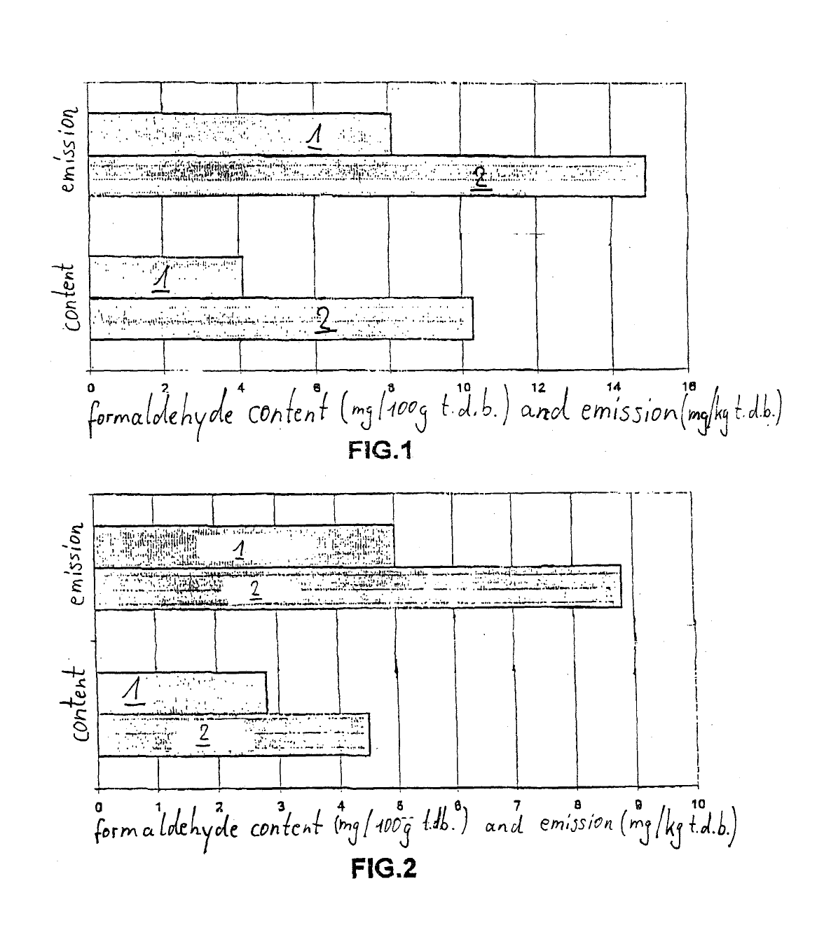

The 1.0:1.2 urea-formaldehyde adhesive resin was used for particles glue-spreading. The applied hardening agent contained known formaldehyde-bonding substances. Pressing was carried out in 218° C., at 11 s/1 mm particleboard thickness pressing time rate. The formaldehyde content in particleboard manufactured according to the conventional method amounted 4.5 mg/100 g totally dry board; whereas formaldehyde emission—6.8 mg/1 kg totally dry board. Following the brief 8 hour seasoning after pressing, and prior to cooling, in 80-85° C. of particleboard internal layer, the formaldehyde content and emission where reduced down to 2.0 mg/100 mg totally dry board and 5.6 mg/1 kg totally dry board, respectively. The particleboard swelling rate after soaking in water diminished by some 25%. The hygienic quality of particleboard manufactured according to the described example is illustrated in FIG. 2.

### EXAMPLE III

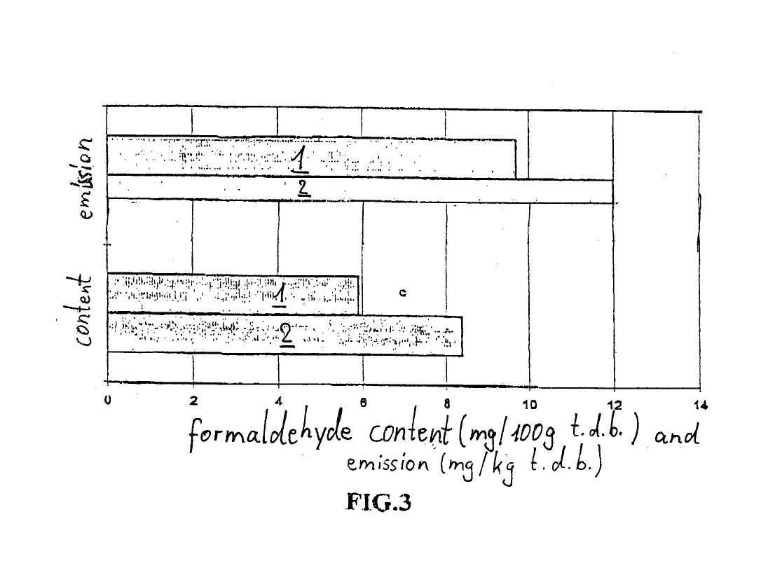

Urea-formaldehyde-melamine resin with ammonium chloride as the hardening agent were used. The board was pressed in 185° C., at 8 s/1 mm board thickness pressing time rate. The formaldehyde content in board cooled prior to conventional seasoning amounted 8.4 mg/100 g totally dry board; whereas formaldehyde emission—12 mg/1 kg totally dry board. Following the brief 6 hour seasoning after pressing, and prior to cooling, in 90° C. of board internal layer, the formaldehyde content and emission were reduced down to 5.9 mg/100 mg totally dry board and 9.7 mg/1 kg totally dry board, respectively. Other properties, including water-resistance test V 100, did not change. The hygienic quality of board manufactured according to the described example is illustrated in FIG. 3.

1. A method for producing a board where in board manufacturing process is carried out comprising a step of heating and pressing several layers, characterized in that the board after pressing, prior to cooling, is subjected to seasoning in 40 to 150° C. for more than 15 minutes.

2. A method according to claim 1 where a layer system having a base plate and a film-like layer impregnated with resin is acted upon in a pressing device with temperature and pressure on both sides in such a way that the layer system is thereby glued together.

3. A method according to claim 1 or 2, characterized in that the board after pressing, prior to cooling, is subjected to seasoning in 70 to 110° C.

4. A method according to claim 1, 2 or 3, characterized in that the board after pressing, prior to cooling, is subjected to seasoning for more than 1 hour.

5. A method according to claim 1, 2, 3 or 4, characterized in that panels are produced from the board which are provided with a groove or a tongue on each outer edges.

6. A method for reducing formaldehyde content and emission from particleboard according to the invention, where in particleboard manufacturing process carried out in a known standard way; with known run; with the application of known amino adhesive resins; with the addition of known hardening agents and/or possible addition of formaldehyde-bonding substances; pressing in stroke of continuous-run presses and cooling, is featured with that particleboard after pressing, prior to cooling, is subjected to brief seasoning in 70-110° C. for several up to a few dozen hours, preferably from 8-16 hours, depending on the expected reduction rate of formaldehyde content and emission and applied manufacturing process parameters.
